(19) United States
(12) Patent Application Publication
(10) Pub. No.: US 2013/0086189 A1
(43) Pub. Date: Apr. 4, 2013

(54) METHOD OF CATEGORIZING MESSAGES RECEIVED BY A USER OF A COMPANY SOCIAL NETWORK

(71) Applicants: Jerome Elleouet, Brest (FR); Cécile Talarmain, Brest (FR)

(72) Inventors: Jerome Elleouet, Brest (FR); Cécile Talarmain, Brest (FR)

(73) Assignee: ALCATEL LUCENT, Paris (FR)

(21) Appl. No.: 13/634,997

(22) PCT Filed: Mar. 4, 2011
(86) PCT No.: PCT/FR2011/050451

§ 371 Date: Nov. 27, 2012

(30) Foreign Application Priority Data
Mar. 18, 2010 (FR) 10/01087

(51) Int. Cl. H04L 12/58

(52) U.S. Cl. CPC H04L 51/32
USPC 709/206

(57) ABSTRACT

The invention relates to a method for categorizing messages received by a user of a company's social network, said method being provided to:
extract an identifier of said message's sender from a received message;
verify the existence within the company's social network of relationships between said identified sender and said user;
apply a categorization role to said message based on said relationships;
transmit the categorized message to said user.

The invention relates to a method for categorizing messages received by a user of a company's social network, as well as an instant communications server within a company's social network, said server comprising means for implementing such a method.

With the progress made over the past few years in telephony and e-mail, communications have become fast and effective, which constitutes a notable advance for companies.

In particular, the use of e-mail has quickly become widespread, particularly owing to its ease of use. A user's e-mail address is easily accessible, so sending an e-mail to said user is very simple.

On the other hand, a user's inbox may quickly become filled with e-mails, in particular advertising e-mails (or spam) that are often undesirable, which may greatly affect the visibility of more important e-mails, and therefore increase the risk of losing said e-mails.

However, losing important e-mails may obviously harm the company, particularly when the e-mails in question deal with the company's business dealings with its clients.

To remedy this problem, some e-mail applications like Microsoft Outlook® or Mozilla Thunderbird® allow a user to categorize the e-mails that she receives, for example, by assigning them a color, which has the advantage of providing the user with visual information that is useful for easily finding important messages.

In these e-mail applications, a user may categorize its e-mails either manually, or by creating a rule that makes it possible to automatically categorize the e-mails based on predefined criteria, as suggested for Microsoft Outlook® by the article available online at the address http://blogs.msdn.com/outlook/archive/2008/12/02/living-in-outlook-automatically-categorize-with-rules.aspx.

However, these options are limited, as they are not exhaustive. For example, if the user decides to create a categorization rule dealing with e-mails whose senders' addresses comprise a suffix specific to said user's company, such a rule will categorize e-mails from said user's fellow employees or line managers and e-mails sent by senders from said company's subsidiaries all in the same way.

The document US-2009/0164588 describes a method for managing e-mails in which an e-mail received by a user is first categorized automatically based on the presence of categorization information for its sender, then manually by said user.

Furthermore, this method for managing e-mails may provide that the e-mail's sender manually categorize said e-mail at the time it is sent to the user, said categorization appearing with said e-mail in said user's inbox.

With respect to telephone calls, there are few satisfactory solutions that make it possible to categorize calls received or missed by a user and/or said user's voicemails.

The document WO-2007/046857 describes a method in which a user may categorize a phone call that she is sending or receiving by pressing some keys on her terminal, so that said call is displayed with a visual indicator, for example an icon, in the received call list of said user's recipient or that of the user herself.

However, the methods described in those two documents have limits, particularly in a professional setting, as they do not take into account information about the professional relationships between the user and her sender/recipient, in particular information from the user's hierarchical tree and/or from her sender/recipient.

Furthermore, other patents and patent applications, as well as software like ClearContext®, offer methods and systems for filing e-mails received by a user into folders, but do not make it possible to resolve the aforementioned problems, as they do not make it possible to improve the visibility of important e-mails, which can lead said user to ignore an important e-mail filed with others in a specific folder.

The invention aims to perfect the prior art, particularly by disclosing a method that makes it possible to automatically categorize messages received by a user in a manner that is exhaustive and adapted to the identifiers of the said messages' senders within a company's social network, as well as relationships between said user and said senders, while ensuring that said user has good visibility of important messages.

To that end, according to a first aspect, the invention discloses a method for categorizing messages received by a user of a company's social network, said method being provided to:
extract an identifier of said message's sender from a received message;
verify the existence within the company's social network of relationships between said identified sender and said user;
apply a categorization role to said message based on said relationships;
transmit the categorized message to said user.

According to a second aspect, the invention discloses an instant communications server within a company's social network, said server comprising:
means for extracting an identifier of said message's sender from a received message;
means for verifying the existence within the company's social network of relationships between said identified sender and said user;
means for applying a categorization role to said message based on said relationships;
means for transmitting the categorized message to said user.

Other features and advantages of the invention will become apparent in the following description, written in connection with the attached figures, in which:

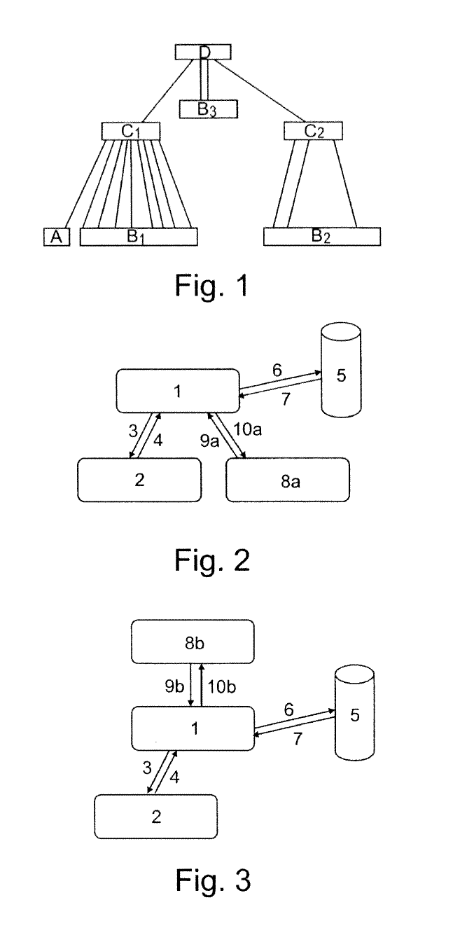

FIG. 1 schematically depicts an example hierarchical tree that may be used in a company's social network;

FIG. 2 depicts an architecture for a company's social network, said architecture particularly comprising an instant communications server capable of implementing a categorization method according to a first embodiment of the invention;

FIG. 3 depicts an architecture for a company's social network, said architecture particularly comprising an instant communications server capable of implementing a categorization method according to a second embodiment of the invention.

In connection with these figures, below is described a method for categorizing the messages received by a user of a company's social network, said method particularly being implemented by means of an instant communications server (ICS) located within said social network.

Currently, social networks occupy a prominent position, and their usage continues to expand, not only on the Internet, such as with Facebook® or Twitter®, but also within companies. Social networks with a firmer footing in a professional context include, for example. LinkedIn®, or Lotus Connections® from IBM®.

In particular, in a company's social network like the ones cited above, a user may be identified by her hierarchical position within said company. For example, the user may be identified with respect to the department in which she works, to her closest staff and her department head, or with respect to the head of the division that includes her department.

With respect to FIG. 1, a user A may be identified with respect to her fellow employees B₁ in the same department and with the head C₁ of said department, or with respect to the head C₂ of another department and his employees B₂, or with respect to the head D of the department that includes those two departments and with the direct employees B₃ of the head D.

To categorize a message received by a user, the method provides for extracting from said message an identifier of its sender, said identifier depending on the nature of said message. To do so, the instant communications server 1 comprises means for extracting from a received message an identifier of its sender.

The method further provides verifying the existence within the company's social network of relationships between the identified sender and the user. To do so, the instant communications server 1 comprises means for verifying the existence of such relationships within at least one database of the company's social network.

In connection with FIGS. 2 and 3, the instant communications server 1 is connected to a server 2 of the company's social network by means of a programming interface (API, for Application Programming Interface), said server comprising at least one database that stores information about said network's users. In particular, the server 2 may comprise a hierarchical tree of the company.

To verify the existence of relationships between the identified sender of a received message and the user, the instant communications server 1 sends a request 3 to the server 2, said request comprising the identifier of the said message's sender.

In response, the server 2 sends the instant communications server 1 a notification 4. If there are relationships between the user and the identified sender, the notification 4 comprises information about said relationships, for example about said sender's hierarchical position with respect to said user, or about the existing relationships between said user's company and the sender.

Furthermore, if there are no relationships between the identified sender and the user, for example if said sender is a person from outside the company who is not in her private or work contacts, the notification 4 indicates the absence of said relationships, and the categorization method shall not apply to said sender's message.

The method for provides for applying a categorization rule to the received message based on existing relationships between said message's sender and the user. To do so, the instant communications server 1 comprises means for applying such a rule.

In connection with FIGS. 2 and 3, the categorization rules are stored in an administration database 5, and the administrator of the company's social network may thereby edit said rules or define new ones by accessing said database.

According to one embodiment, the method may include providing default categorization rules, which the administrator of the company's social network may edit in order to adapt them to said company's specific needs, particularly to update them with any changes to said network's hierarchical tree, or with regard to the nature of the contacts of said network's users.

To tell which categorization rule to apply to the received message, the instant communications server 1 sends a request 6 to the administration database 5, said request comprising information previously obtained from the server 2 regarding the relationships between said message's sender and the user. The database 5 then sends a notification 7 comprising the required categorization rule, if it exists.

In particular, the categorization rule may deal with the hierarchical position of the received message's sender with respect to the user. To that end, this hierarchical position may obviously determine the message's level of importance; for example, the higher it is, the more important said message will be.

With respect to FIG. 1, if the sender is on the same hierarchical level as the user A, meaning if said sender is, for example, an employee B₁ of the same department as said user, an employee B₂ of another department, or an employee B₃ of the head D of the division that comprises said user's service, a received message may be considered of medium importance.

If the sender is a line manager of the user, for example her immediate manager C₁ or the manager C₂ of another department which is at the same hierarchical level as said immediate manager, the received message may be considered high-importance.

Finally, if the sender is a major line manager, for example the head D of the department that comprises said user's service, the director of human resources, or even the company's chief executive officer, the received message may be considered to be very high importance.

The categorization rule may also cover professional relationships other than hierarchical ones between the sender and the user, for example if the sender is a known professional contact of said user's company, such as a client or contact of said company.

The categorization rule may also cover non-professional relationships between the sender and the user, for example if the sender is one of the user's private contacts.

Furthermore, if there is no categorization rule for the existing relationship between the sender and the user, or if said sender has no relationship with the user, the received message will not be categorized, and may therefore be considered by the user as being of lesser importance compared to any other messages categorized by the method.

Once the received message has been categorized, the method provides for transmitting it to the user. To do so, the instant communications server 1 comprises means for transmitting the categorized message to the user, said user then being able to view it on her terminal.

Furthermore, according to one preferred embodiment, the categorization rule may comprise the assigning of a visual indicator to the categorized message, said assigning being carried out by the transmissions means of said instant communications server 1. For example, the categorized message may be assigned a color specific to its category, said color potentially also emphasizing said message's degree of importance, by being more eye-catching or less.

According to one embodiment, the categorized message is transmitted to the user by means of a programming interface, said programming interface varying based on the nature of said user's terminal, and in particular based on the nature of said message. Furthermore, the instant communications server 1 may assign a visual indicator to the categorized message by means of said programming interface.

In connection with FIG. 2, below is described a first embodiment of the invention, in which the message received by the user is an e-mail. The categorization method is then initiated by the user's e-mail server 8a, after a new message is received.

E-mail servers that are commonly used, particularly within companies, include, for example, the successive versions of Microsoft Exchange®, or the Domino® server from IBM®.

In this embodiment, the instant communications server 1 is connected to the user's e-mail server 8a by means of a programming interface, for example by means of an extension module (a plug-in) located within said e-mail server.

According to one embodiment, the instant communications server 1 may comprise a complementary instant communications server module that is connected to the user's e-mail server 8a, for example by means of Internet services, as is the case for the e-mail server Microsoft Exchange 2007®.

When a new message is received, the instant messaging server 8a sends a notification 9a, by means of the aforementioned programming interface, to the instant communications server 1. The instant communications server 1 then extracts from the received message its sender's identifier, said identifier comprising in particular said sender's e-mail address.

Next, as previously described, the server 1 first verifies the existence, in at least one database of the company's social network, relationships between the message's sender and the user, then applies a categorization rule to said message based on said relationships.

In particular, in this embodiment, if the message's sender is a private contact of the user, the server 1 may verify within a database of the e-mail server 8a the existence of relationships between said sender and said user.

The instant communications server 1 finally transmits the categorized message to the e-mail server 8a by sending it, by means of the programming interface, a notification 10a comprising said message.

Thus, when the user checks her received messages, she can see, via the GUI (Graphical User Interface) of her e-mail server 8a, the message categorized among her other messages, said categorized message further comprising, according to one preferred embodiment, a visual indicator, for example highlighting using the color that corresponds to said message's category, so that it is easily visible to said user.

With respect to FIG. 3, below is described a second embodiment of the invention, in which the message received by the user is a telephone call notification from the sender, said notification potentially further indicating to the user the existence of a voicemail for said user.

In this second embodiment, the categorization method is initiated by a request (not depicted in the Figure) sent by the user to an instant communications client 8b to check the message, for example by activating a function of said client's graphical user interface on her own terminal.

Commonly used instant communications clients include, for example, the application My Instant Communicator® from Alcatel-Lucent®. In particular, depending on the instant communications client installed in the company's social network, the user can activate an interactive button on said client's graphical user interface in order to check her call log, and thereby to activate the categorization method.

The instant communications client 8b sends the instant communications server 1 a notification 9b indicating that the user asked to check her messages. For each message, the instant communications server 1 then extracts an identifier from its sender, said identifier potentially, for example, comprising said sender's phone number.

Next, as previously described, the server 1 first verifies the existence, in at least one database of the company's social network, relationships between the message's sender and the user, then applies a categorization rule to said message based on said relationships.

In particular, in this embodiment, if the message's sender is a private contact of the user, the server 1 may verify within a database of the instant communications client 8b the existence of relationships between said sender and said user.

The instant communications server 1 finally transmits the categorized message to the instant communications client 8b by sending it a notification 10b comprising the user's call log, within which said categorized message is found.

Thus, whenever the user checks her call log, she can see, via the graphical user interface of the instant communications client 8b, the message categorized among her other messages, said categorized message further comprising, according to one preferred embodiment, a visual indicator, for example highlighting using the color that corresponds to said message's category, so that it is easily visible to said user.

1. A method for categorizing messages received by a user of a company's social network, said method being provided to:
extract an identifier of said message's sender from a received message;
verify the existence within the company's social network of relationships between said identified sender and said user;
apply a categorization role to said message based on said relationships;
transmit the categorized message to said user.

2. A categorization method according to claim 1, wherein the message received by the user is an e-mail, the extracted identifier comprising the sender's e-mail address.

3. A categorization method according to claim 2, wherein it is initiated by the e-mail server (8a), after a new message is received.

4. A categorization method according to claim 1, wherein the message received by the user is a phone call notification from the sender.

5. A categorization method according to claim 4, wherein it is initiated by a request sent by the user to check the message.

6. A categorization method according to claim 1, wherein the categorization rule comprises the assigning of a visual indicator to the message.

7. A categorization method according to claim 1, wherein the categorized message is transmitted to the user by means of a programming interface.

8. A categorization method according to claim 1, wherein the categorization rules are stored in an administration database (5).

9. An instant communications server (1) within a company's social network, said server comprising:
means for extracting an identifier of said message's sender from a received message;
means for verifying the existence within the company's social network of relationships between said identified sender and said user;
means for applying a categorization role to said message based on said relationships;
means for transmitting the categorized message to said user.

10. An instant communications server (1) according to claim 9, wherein it comprises a complementary instant communications server that is connected to the user's e-mail server (8a).
